(19) United States
(12) Patent Application Publication
(10) Pub. No.: US 2002/0148633 A1
(43) Pub. Date: Oct. 17, 2002

(54) Waterproof connector and rubber stopper thereof

(75) Inventor: Masahiro Kanda, Shizuoka (JP)

Correspondence Address: ARMSTRONG,WESTERMAN & HATTORI, LLP, 1725 K STREET, NW., SUITE 1000, WASHINGTON, DC, 20006, US

(73) Assignee: Yazaki Corporation, Tokyo (JP)

(21) Appl. No.: 10/050,170

(22) Filed: Jan. 18, 2002

(30) Foreign Application Priority Data
Feb. 7, 2001 (JP) 2001-31084

(51) Int. Cl. H02G 15/02

(52) U.S. Cl. 174/77 R

(57) ABSTRACT

A rubber stopper used in a waterproof connector is disposed between a covered cable and a connector housing of the waterproof connector. The rubber stopper includes a silicon rubber as a major constituent and a bonding agent to bond a covering layer of the covered cable to the rubber stopper when the rubber stopper is heated. Another rubber stopper includes an organic rubber as a major constituent and a plasticizer soluble mutually with a resin material constituting the covering layer of the covered cable.

### BACKGROUND OF THE INVENTION

1. Field of the Invention

The present invention relates to a waterproof connector having a waterproof rubber stopper disposed between the connector and a covered cable connected to the connector.

2. Related Art

A waterproof connector has a rubber stopper disposed between the connector and a covered cable to provide a waterproof seal therebetween. Generally, there are two types of the waterproof stoppers, one of which is an independent rubber tubular stopper associated with each of the covered cables. The other type is a rubber stopper seat having a plurality of through holes each receiving the covered cable.

Next, referring to FIG. 1, a rubber tubular stopper and an application example thereof will be discussed.

In FIG. 1, reference numeral 1 designates an independent rubber tubular stopper. The stopper has a through hole 1a at a middle thereof, into which a covered cable 2 is inserted. An covering layer 2a of the cable 2 is partially removed so that a conductor 2b is exposed. Then, the conductor 2b of the covered cable 2 is connected to a wire crimping barrel 3b of a terminal 3 by press-fitting, soldering, or the like. The terminal 3 has a rubber stopper coupling barrel 3c at a base portion thereof, which is bent to hold the rubber tubular stopper 1. The rubber tubular stopper 1 has a lip 1b to prevent disengagement of the stopper 1 from the barrel 3b.

The rubber stopper 1 and the terminal 3 connected to the covered cable 2 are inserted into a terminal insertion chamber (not shown) of a housing 4 of the waterproof connector. The terminal 3 is locked to the terminal chamber by engaging a locking piece (not shown) formed in the terminal chamber with a hooking shoulder 3d of the terminal 3. At the same time, a watertight seal is accomplished between an inner surface of the terminal chamber and the covered cable 2 by a resilient sealing portion 1c of the rubber tubular stopper 1.

Thus configured rubber tubular stopper is generally used to seal a covered cable having a comparatively larger diameter. The stopper is required for each terminal chamber of the connector housing for receiving each cable.

The rubber tubular stopper includes an oleo-rubber (or an oleo-silicon-rubber) as a major constituent, a crosslinking agent, a filler, etc. to achieve a sufficient compression ratio.

The compression ratio (%) is obtained according to the following formula (1).

A: a maximum inner diameter of a sealing portion of a terminal insertion hole formed in the connector housing;

B: a maximum outer diameter of a sealing part of the rubber stopper;

C: a maximum inner diameter of the sealing part of the rubber stopper; and

D: a maximum outer diameter of the covered cable.

### Formula 1

[((B−C)−(A−D))/(B−C)]×100

According to an application condition, the compression ratio is designed to be normally about 15 to 40%, preferably 20 to 40%.

However, a permanent strain occurs in rubbers which are used in a compressed state. Thus, the rubbers initially provide a sufficient sealing but decrease in the compression ratios thereof due to its long use or on exposure to a high temperature.

FIG. 2 illustrates a seat-type rubber stopper. The seat-type rubber stopper engages with a waterproof hood provided in a terminal insertion side of a waterproof connector. The rubber stopper is provided for a plurality of covered cables associated with the connector.

Japanese Patent Application Publication No. H. 9-511864 discloses such an art in which a seat-type rubber stopper has a sealant piece sandwiched by two comparatively hard wall pieces.

Such a conventional seat-type rubber stopper has a plurality of through holes for covered cables associated with a waterproof connector. Each through hole should have an inner diameter to seal each covered cable. However, when the covered cable has a conductor having a sectional area less than 0.13 mm², a molding pin for forming the through hole should have a diameter less than 0.6 mm. The small diameter frequently causes a breakage of the pins, impeding a stable forming of the through holes.

For a solution of the drawback of the conventional seat-type rubber stopper, the Japanese Patent application Publication No. H. 9-5118644 proposes an art of a seat-type rubber stopper as illustrated in FIG. 2. The seat-type rubber stopper has a plurality of gel sealant pieces 5 sandwiched between two hard wall pieces 6a (a case in this example) and 6b. The sealant piece 5 can easily seal covered cables. The wall piece 6a holds the gel sealant pieces 5. The wall pieces 6a and 6b are inserted into a terminal insertion side waterproof hood 7a of a waterproof connector housing 7.

However, such a soft gel sealant piece has a considerably low crosslink density, so that a compression permanent strain of the sealant piece is too large to provide a sufficient sealing property at 120 to 140° C. This degrades a sealing property of the conventional rubber stopper.

The waterproof connector rubber stopper having the soft gel sealant pieces that decrease in the compression ratio due to a thermal history can not be used in an automobile engine room of a high temperature condition. Moreover, the three piece construction of the rubber tubular stopper is disadvantageous in forming and productivity of the waterproof connector.

### SUMMARY OF THE INVENTION

For solution of the disadvantage of the conventional art, an object of the invention is to provide a rubber stopper of a waterproof connector, the rubber stopper being able to keep a sufficient sealing property even in use at a comparatively high temperature.

For achieving the object, a first aspect of the invention is a rubber stopper used in a waterproof connector, the rubber stopper disposed between a covered cable and a connector housing of the waterproof connector, wherein the rubber stopper includes a material that can bond the rubber stopper to a covering layer of the covered cable when the rubber stopper is heated.

The waterproof connector having thus configured rubber stopper can keep a sufficient sealing property even when the rubber stopper has decreased in the-compression ratio thereof due to a thermal history. Because, the thermal history bonds the rubber stopper to the cable to allow a sufficient sealing threbetween.

Since the rubber stopper of the waterproof connector has no bonding property before its thermal history. Thus, no interruption is made in an assembling work of the waterproof connector to pass the covered cable through the rubber stopper.

Even a small diameter covered cable which has been difficult to achieve a waterproof performance thereof can be used in the configuration of the present invention. Because, a molding pin forming a through hole for the cable can have a larger diameter than the conventional art since the rubber stopper can have a sufficient waterproof performance after the reception of a thermal history. Thus, no damage of the molding pins occurs, improving a workability thereof, and clumping chucks for the molding pins are omitted. This considerably decreases a manufacturing cost of the waterproof connector.

When a covering layer of the covered cable includes a vinyl chloride resin or a polyvinyl chloride resin, the invention described in claim 2 provides a high sealing property. In claim 2, a material bonding the covering layer to the rubber stopper is an oleo-rubber that includes an organic rubber as a major constituent and a di-2-ethylhexyl phthalate and/or a high-grade alcohol phthalate.

When a covering layer of the covered cable includes a vinyl chloride resin or a polyvinyl chloride resin, the invention described in claim 3 provides a considerably high sealing property after heating of the rubber stopper. In claim 3, a material bonding the covering layer to rubber stopper is an oleo-rubber that includes a compound comprising at least one of silylidyne groups.

A second aspect of the invention is a waterproof connector having a waterproof rubber stopper that includes an organic rubber as a major constituent, the rubber stopper disposed between the waterproof connector and a covered cable, wherein the rubber stopper includes a plasticizer soluble mutually with to a resin material constituting a covering layer of the covered cable. This achieves an improved waterproof performance after a thermal history since the plasticizer compatible with the resin material constituting the covering layer is selected.

A third aspect of the invention is a waterproof connector having a waterproof rubber stopper that includes a silicon rubber as a major constituent, the rubber stopper disposed between the waterproof connector and a covered cable, wherein the rubber stopper includes a bonding agent to bond a covering layer of the covered cable to the rubber stopper when the rubber stopper is heated. This achieves an improved waterproof performance after a thermal history.

### BRIEF DESCRIPTION OF THE DRAWINGS

FIG. 1 shows illustrative side views of a connector using an independent rubber tubular stopper;

FIG. 2 is an exploded perspective view of a connector using a seat-type rubber stopper of a conventional art; and

FIG. 3 is an illustration showing a method of an airtight seal property test of a connector.

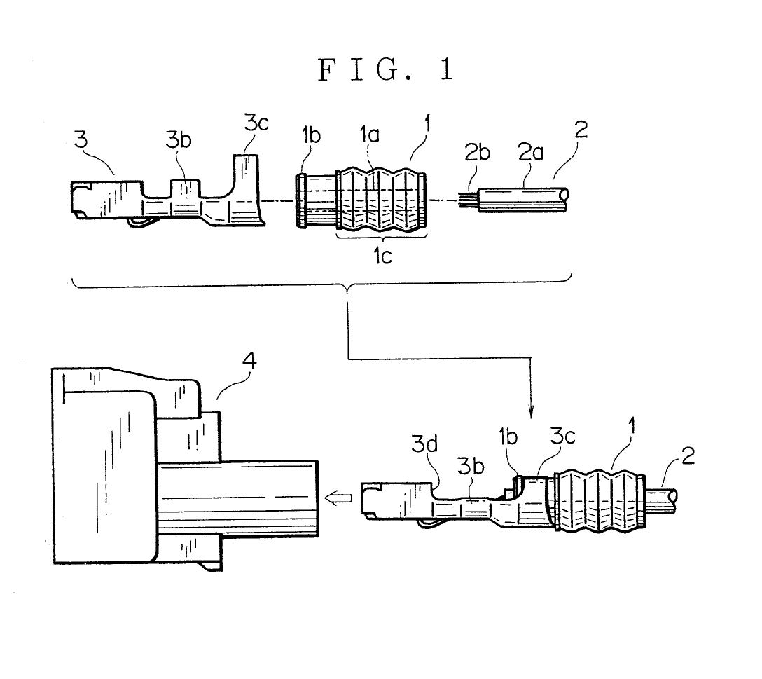

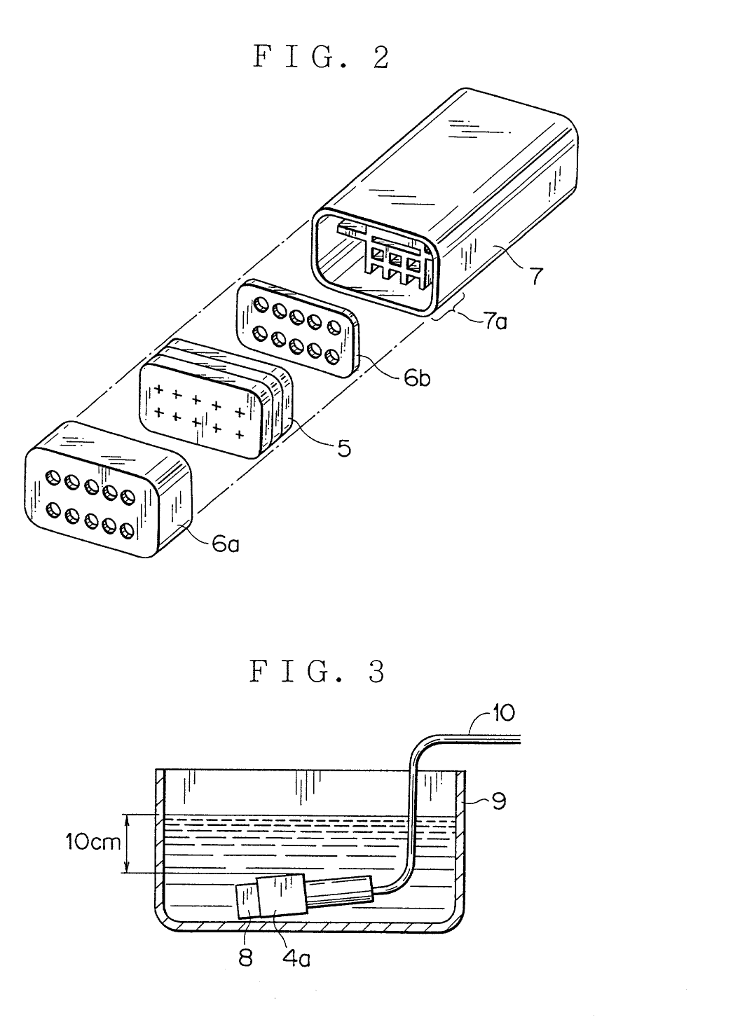

### DETAILED DESCRIPTION OF THE PREFERRED EMBODIMENT

A rubber stopper used in a waterproof connector according to the present invention includes preferably an oleo-rubber as a base material to obtain a high waterproof performance. Such an oleo-rubber is a general organic rubber like an acrylonitrile-butadiene rubber and an oleo-ethylene-propylene-diene rubber or may be a silicon rubber like an oleo-silicon rubber.

An organic rubber of a non-silicon rubber group having a heat resisting property like an oleo-acrylonitrile-butadiene rubber or an oleo-ethylene propylene diene rubber is used particularly to have no adverse effects on a relay contact. In that case, a plasticizer is preferably added to the organic rubber soluble mutually with the covering layer of the covered cable to provide a bonding property to the organic rubber.

When the covering layer of the covered cable is made of a vinyl chloride group resin which is commonly applied, the plasticizer is preferably a di-2-ethylhexyl phthalate (DOP) that achieves a sufficient waterproof property even a small amount addition thereof.

Preferably the organic rubber includes 0.5 to 50 weight units of a plasticizer soluble mutually with the covering layer relative to 100 weight units of a basic compound. The plasticizer of 10 to 30 weight units is further preferable. A less than 0.5 weight units of the plasticizer can not provide a sufficient bonding property, and more than 50 weight units of the plasticizer disadvantageously decrease a heat resisting property of the rubber.

The plasticizer may be a di-2-ethylhexyl phthalate or a high-grade alcohol phthalate like a di-isodecyl phthalic acid (DIDP).

On the contrary, when a silicon rubber is a basic material, an addition of a di-2-ethylhexyl phthalate or a high-grade alcohol phthalate to the silicon rubber has an adverse effects on a heat resisting property of the rubber. Such a silicon rubber may be mixed with a bonding agent to bond the covering layer of the covered cable to the rubber stopper when heated to provides a sufficient waterproof property thereof.

The bonding agent may be a compound including at least one of silylidyne groups (Si-H groups) to bond the covering layer to the waterproof rubber stopper but the compound normally includes one to ten of silylidyne groups.

The bonding agent including at least one of functional groups selected from an epoxy group, an alkoxyl group, and an anhydrous carboxylic acid group in addition to a silylidyne group provides a higher water-resisting property for a long period.

An example of such a compound is a straight-chain or cyclic organosiloxane oligomer including silicones of which a number is more than one and less than 21, or an organic silicon compound like an organosiloxane oligomer of phenyl or phenylene construction having 2 to 20 silicones of a straight-chain (including branches) or cyclic configuration.

Preferably, the addition quantity of the bonding agent relative to 100 weight units of the silicon rubber compound is more than 0.1 weight units and less than 20 weight units. A less than 0.1 weight units of the bonding agent can not provide a sufficient bonding property, and more than 20 weight units of the bonding agent possibly cause the disadvantage that the rubber is stuck to a molding die during a forming process of the rubber. Further preferably, the addition quantity of the bonding agent is more than 6 weight units and less than 15 weight units.

In addition to the aforementioned constituents, the rubber compound for the waterproof connector rubber stopper according to the present invention may include a curing agent, a curing accelerating agent, an antioxidant, a pigment, a filler (for a resiliency adjustment), etc., an addition ratio of which is limited not to degrade the effect of the present invention.

These constitutional materials are mixed or kneaded by means of a tandem roller, a Banbury mixer, or a kneader and delivered into a cavity of a molding die to form the stopper in a conventional process.

### Embodiments

Embodiments of the waterproof connector rubber stopper according to the present invention will be discussed more specifically hereinafter.

### Embodiment 1

An oleo-acrylonitrile butadiene rubber compound (called as a NBR compound hereinafter) of 100 weight units, which is an organic rubber compound including constituents described in Table 1, is mixed with 10 weight units of a di-2-ethylhexil phthalate (DOP) to be kneaded by a kneader. The DOP is a plasticizer soluble mutually with a vinyl chloride resin constituting a covering layer of a covered cable.

TABLE 1

| | | WEIGHT |
|---|---|---|
| CONSTITUENT | PRODUCT NAME (PRODUCING COMPANY) | UNITS |
| Basic Rubber | N250S (Nippon Synthetic Rubber Co.) | 100 |
| Filler | NIPSILVN3 (Nippon Silica Industry Co.) | 35 |
| Filler | Barges KE (Barges Pigment Co.) | 30 |
| Carbon Black | ASAHI#50 (Asahi Carbon Co.) | 3 |
| Plasticizer | PW90 (Idemitu Kosan Co.) | 6 |
| Plasticizer | RS107 (Asahi Denka Kogyo Co.) | 23 |
| Plasticizer | POLYBIS3SH (NOF Co.) | 10 |
| Plasticizer | POLYBIS015SH (NOF Co.) | 10 |
| Curing | Activated Zinc Flower | 3 |
| Accelerator | (Sakai Chemical Industry Co.) | |
| Curing | Polyethylene glycol | 3 |
| Accelerator | | |
| Antioxidant | BHT (Kawaguti Chemical Industry Co.) | 0.5 |
| Antioxidant | RD (Kawaguti Chemical Industry Co.) | 1 |
| Curing agent | Parkmill D40 (NOF Co.) | 1.5 |

Then, an independent rubber tubular stopper A was formed by a conventional method in use of a molding die and had been kept at 170° C. for six minutes.

### Embodiment 2

An oleo-silicon rubber compound (DY32-3050u produced by Toray Dou Cornning Silicon Rubber Corporation) of 100 weight units was mixed with 6 weight units of a bonding agent to be kneaded by a tandem roll. The bonding agent is a straight-chain organosiloxane oligomer of a p-phenylene construction. The oligomer has a silicon having four branches to join three silylidyne groups. The oligomer is a compound (a product of Toray Dou Cornning Silicon Rubber Corporation) shown by a chemical formula (1) to bond the covering layer of the covered cable to the waterproof rubber stopper when heated.

### Chemical Formula 1

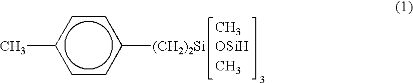

Then, an independent rubber tubular stopper B was formed by using a molding die in a conventional method and had been kept at 170° C. for four minutes.

### Comparison Examples

In use of a conventional method, rubber tubular stoppers C and D were formed to have the same shape as the rubber tubular stoppers A and B. However, the rubber tubular stopper C was not mixed with a di-2-ethylhexil phthalate, and the rubber tubular stopper D was not mixed with a compound shown by the chemical formula (1).

### Initial Waterproof Property Evaluation

Each of the rubber tubular stoppers A to D was formed into a vinyl chloride resin tube having a compression ratio of 12% so as to receive a vinyl chloride resin covered cable having a conductor sectional area of 0.13 mm². Then, an experimental waterproof connector was defined to have a connector housing with eight poles and was connected to seven covered cables.

For waterproof evaluation of the experimental connector, an airtight seal property thereof was tested. The connector has a waterproof connector housing 4 formed with a coupling hood 4a for mating with an opposed connector. The coupling hood 4a is closed by a waterproof plug 8, and, as illustrated in FIG. 3, the waterproof connector is lowered into a water bath 9 up to a depth of about 10 cm. Then, an inside pressure of the waterproof connector was increased step by step at a rate of 9.8 kPa per 30 seconds by using a vinyl chloride tube 10, while an air leakage of the waterproof connector was monitored. A result of the experiment showed that all the waterproof connectors experienced no air leakage even a pressure of 200 kPa to prove a sufficient water-resisting property of the connectors.

### Waterproof Property Evaluation after Thermal History

The waterproof connector having the waterproof rubber stopper A or C made of an organic rubber had been exposed in an air of 80° C. for 500 hours to give a thermal history. The waterproof connector having the waterproof rubber stopper B or D made of a silicon rubber had been exposed in an air of 120° C. for 1000 hours to give a thermal history. The thermal history bonds the waterproof rubber stopper A or B to the covered cable.

After the thermal histories, these waterproof connectors were evaluated in a waterproof property. The evaluation results are shown in Table 2.

TABLE 2

| Connector Name | A | B | C | D |
|---|---|---|---|---|
| Initial | over | over | over | over |
| waterproof property | 200 kPa | 200 kPa | 200 kPa | 200 kPa |
| Waterproof property | over | 140 kPa | less than | 30 kPa |
| after thermal history | 120 kPa | | 9.8 kPa | |

Table 2 shows that the waterproof connectors having the rubber tubular stopper A or B according to the present invention maintains a sufficient airtight seal property after the thermal history as compared with a standard airtight seal property at 100 kPa. Thus, the rubber tubular stoppers A and B according to the present invention could be used in a waterproof connector disposed in a high temperature location like an engine room of an automobile.

The rubber tubular stoppers A and B have an initial compression ratio of 12% so that the through hole receiving the covered cable can have an inner diameter larger than a conventional one. Thus, a molding pin for the through holes can be repeatedly used without any damage of the pin, allowing a stable molding work thereof.

### Embodiments and Comparison Examples Having Different Kinds of and Different Addition Rates of Plasticizers

Similarly to Embodiment 1, independent rubber tubular stoppers were molded to be assembled into waterproof connectors. In the rubber tubular stoppers, the addition ratio of a di-2-ethylhexyl phthalate was varied as shown in Table 3, and in place of the di-2-ethylhexyl phthalate, a phthalic acid di-isodecyl (called as DIDP) was used in Embodiment 5. An evaluation result thereof is shown in Table 3.

TABLE 3

| | Embodiment 3 | Embodiment 4 | Embodiment 5 |
|---|---|---|---|
| NBR Compound | 100 | 100 | 100 |
| (Weight Units) | | | |
| DOP | 30 | 60 | |
| (Weight Units) | | | |
| DIDP | | | 20 |
| (Weight Units) | | | |
| Initial | over | over | over |
| waterproof property | 200 kPa | 200 Kpa | 200 kPa |
| Waterproof property | over | 30 kPa | 160 kPa |
| after thermal history | 200 kPa | | |

Note: In Embodiments 4 and 5, air bubbles occurred at a sealing portion between the rubber stopper and the connector housing.

Referring to Table 3, the phthalic acid di-isodecyl which is a high-grade alcohol phthalate can be successfully used as well as the di-2-ethylhexyl phthalate. Although there was the occurrence of a small amount of air bubbles in Embodiments 4 and 5 at a sealing portion between the rubber stopper and the connector housing, a sufficient sealing property was maintained in the Embodiments with no problems.

Similarly to Embodiment 2, the addition ratios of compounds having chemical formula (1) were varied as described in Table 4, or, in place of the compound shown by the chemical formula (1), another bonding agent defined by chemical formula (2) was applied. The another bonding agent is a cyclic organosiloxane oligomer (a product of by Toray Dou Cornning Silicon Rubber Corporation). Rubber tubular stoppers were molded so as to include the bonding agent so that the rubber stoppers could be bonded to the covering layers of the covered cables when heated. Then, waterproof connectors were assembled in use of the tubular stoppers similarly to the aforementioned method, and an evaluation test result of thus configured waterproof connectors is shown in Table 4.

### Chemical Formula 2

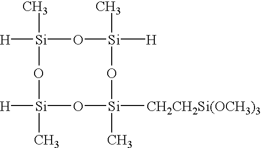 TABLE 4

| | Embodiment | Embodiment | Experimental |
|---|---|---|---|
| | 6 | 7 | Example 1 |
| Oleo-Silicon | 100 | 100 | 100 |
| Rubber Compound | | | |
| (Weight units) | | | |
| Compound of | 15 | | |
| Chemical Formula 1 | | | |
| (Weight units) | | | |
| Compound of | | 4 | 20 |
| Chemical Formula 2 | | | |
| (Weight units) | | | |
| Initial | over | over | none |
| waterproof | 200 kPa | 200 kpa | |
| property | | | |
| Waterproof property | over | 180 kPa | none |
| after thermal history | 200 kPa | | |

Note: In Experimental Example 1, a rubber stopper could not be molded because the rubber was stuck to a molding die during a molding process of the stopper.

Table 4 shows that the compound of chemical formula (2) can be used as well as the compound of chemical formula (1).

The present invention can provide a waterproof connector rubber stopper having a larger compression ratio with a sufficient water-resisting property. The rubber stopper can maintain the water-resisting property even after a long-time thermal history and is improved in a stable productivity.

What is claimed is:

1. A rubber stopper used in a waterproof connector, the rubber stopper disposed between a covered cable and a connector housing of the waterproof connector, characterized in that the rubber stopper includes a material that can bond the rubber stopper to a covering layer of the covered cable when the rubber stopper is heated.

2. The rubber stopper set forth in claim 1 wherein the material bonding the covering layer to the rubber stopper is an oleo-rubber that includes an organic rubber as a major constituent and a di-2-ethylhexyl phthalate and/or a high-grade alcohol phthalate.

3. The rubber stopper set forth in claim 1 wherein the material bonding the covering layer to the rubber stopper is an oleo-rubber that includes a compound comprising at least one of silylidyne groups.

4. The rubber stopper set forth in claim 1 wherein a heating temperature during the heating is higher than a temperature at which the rubber stopper is assembled in the connector.

5. A waterproof connector having a waterproof rubber stopper that includes an organic rubber as a major constituent, the rubber stopper disposed between the waterproof connector and a covered cable, wherein the rubber stopper includes a plasticizer soluble mutually with a resin material constituting a covering layer of the covered cable.

6. The waterproof connector set forth in claim 5 wherein the plasticizer is a di-2-ethylhexyl phthalate or a phthalic acid di-isodecyl.

7. A waterproof connector having a waterproof rubber stopper that includes a silicon rubber as a major constituent, the rubber stopper disposed between the waterproof connector and a covered cable, wherein the rubber stopper includes a bonding agent to bond a covering layer of the covered cable to the rubber stopper when the rubber stopper is heated.

8. The waterproof connector set forth in claim 7 wherein the bonding agent is a straight-chain organosiloxane oligomer of a p-phenylene construction or a cyclic organosiloxane oligomer.
